(19) United States
(12) Patent Application Publication
(10) Pub. No.: US 2013/0238883 A1
(43) Pub. Date: Sep. 12, 2013

(54) UPPER LAYER DESCRIPTION GENERATOR, UPPER LAYER DESCRIPTION GENERATION METHOD, AND COMPUTER READABLE STORAGE MEDIUM

(71) Applicant: CANON KABUSHIKI KAISHA, Tokyo (JP)

(72) Inventor: Shinya Yamada, Tokyo (JP)

(73) Assignee: CANON KABUSHIKI KAISHA, Tokyo (JP)

(21) Appl. No.: 13/783,072

(22) Filed: Mar. 1, 2013

(30) Foreign Application Priority Data
Mar. 8, 2012 (JP) 2012-051631
Oct. 10, 2012 (JP) 2012-225205

(51) Int. Cl. G06F 9/445

(52) U.S. Cl. CPC G06F 9/44505
USPC 713/1

(57) ABSTRACT

There is an issue of a great workload in changing an upper layer configuration. The present invention solves the issue by including a generation unit configured to generate an instance description by keyword replacement based on one or more instance template files in which an instance description for each module is described by a keyword and a parameter file representing a configuration of an upper layer, and an arrangement unit configured to arrange the instance description generated by the generation unit as a description conforming to grammar of each language, and output a upper layer description.

### BACKGROUND OF THE INVENTION

1. Field of the Invention

The present invention relates to an upper layer description generator, an upper layer description generation method, and a computer readable storage medium.

2. Description of the Related Art

In the present invention, a “module” represents a constituent element of a system, and includes a logical circuit description and a verification model monitor. An “upper layer” represents a system that can be build by assembling the module, and is written in a Hardware description language and a hardware verification language.

The Hardware description language has a configuration changing function. To take a very-high-speed-integrated-circuits hardware description language (VHDL) as an example, the following are the configuration changing function. A generic parameter can change a bus width, a configuration statement can replace an architecture portion, and an if-generate statement can change a description.

Japanese Patent Application Laid-Open No. 10-187791 discusses a technique for automatically generating a specific circuit for each of modules based on an information palette describing a method for coupling to the other modules.

A tool having a function of changing an upper layer configuration also exists. In 1Team (trademark)-GENESIS manufactured by Atrenta Inc., for example, a script including a connection method and an instance method is to be generated to cope with a change in the type of modules required to constitute an upper layer and an increase or decrease in the number of modules. A target upper layer description can be automatically generated by the script.

To constitute an upper layer using the VHDL and the 1Team-GENESIS, a maximum configuration needs to be first prepared. The maximum configuration is generated by a designer of the upper layer, and includes all upper layer configurations that are desired to be generated by the designer. A certain desired configuration can be generated by selecting a required constituent element from the maximum configuration because the maximum configuration includes the desired configuration when the maximum configuration is generated.

However, in the conventional technique, there is an issue of a great load in preparation required to enable an upper layer configuration to be changed. If the maximum configuration does not include the desired configuration in the VHDL and the 1Team-GENESIS, for example, the maximum configuration needs to be generated again when a larger number of modules than expected are required and an unexpected type of module is required. Therefore, a great load is produced. On the other hand, when the maximum configuration is generated based on the information pallet, a predetermined description rule for clarifying each of conditions required for the generation is prepared separately from the Hardware description language, so that an error easily occurs in a description and a correction of the condition. Therefore, a great load is produced.

### SUMMARY OF THE INVENTION

According to an aspect of the present invention, an upper layer description generator includes a generation unit configured to generate an instance description based on one or more instance template files in which an instance description for each module is described by a keyword and a parameter file representing a configuration of an upper layer, and an arrangement unit configured to arrange the instance description generated by the generation unit into a description conforming to grammar of each language, and output an upper layer description.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a hardware configuration of an upper layer description generator.

FIG. 2 illustrates an example of a functional configuration of the upper layer description generator.

FIG. 3 illustrates an example of an upper layer that can be generated by the upper layer description generator.

FIG. 4 illustrates a more detailed connection relationship in an upper layer illustrated in FIG. 3.

FIG. 5 illustrates an example of an instance template file relating to a clock generation module.

FIG. 6 illustrates an example of an instance template file relating to an AHB master.

FIG. 7 illustrates an example of an instance template file relating to an AHB decoder.

FIG. 8 illustrates an example of a keyword replacement result obtained when two slaves are connected to a decoder.

FIG. 9 illustrates one of instance template files used to generate an upper layer and an example of a file for expressing a description not included in the other instance template files.

FIG. 10 illustrates an example of a parameter file.

FIG. 11 is a flowchart illustrating an example of processing of a keyword replacement unit.

FIG. 12 illustrates an outline of a description in a VHDL of an upper layer finally output.

FIG. 13 is a flowchart illustrating an example of processing of a description arrangement unit.

FIG. 14 illustrates a configuration of a new upper layer for representing a module addition method.

FIG. 15 illustrates an example of an instance template file relating to an AHB bus bridge.

FIG. 16 illustrates an example of a parameter file for generating an upper layer in the present exemplary embodiment.

### DESCRIPTION OF THE EMBODIMENTS

Various exemplary embodiments, features, and aspects of the invention will be described in detail below with reference to the drawings.

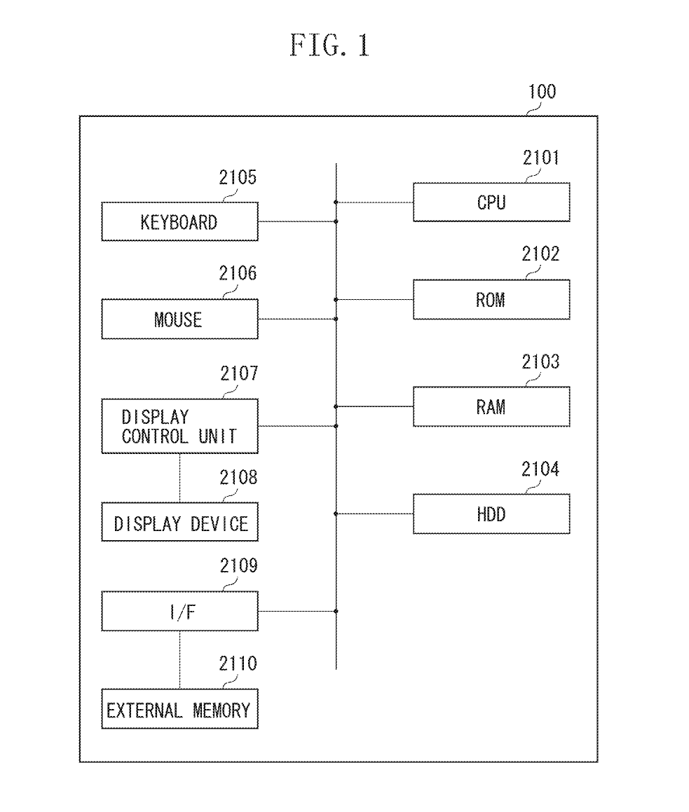

A first exemplary embodiment will be described. FIG. 1 illustrates an example of a hardware configuration of an apparatus as an upper layer description generator 100. A central processing unit (CPU) 2101 controls the entire apparatus. A read-only memory (ROM) 2102 stores a boot program or the like. A random access memory (RAM) 2103 is used as a work area of the CPU 2101, and stores an operating system (OS) and a program of an application.

A hard disk drive (HDD) 2104 stores an OS, a program of an application for generating an upper layer description, and various data.

A keyboard 2105 and a mouse 2106 function as a user interface. A display control unit 2107 contains a video memory and a display controller. A display device 2108 receives and displays a video signal from the display control unit 2107.

An interface (I/F) 2109 communicates with various types of external devices. For example, an external memory 2110 is connected to the interface (I/F) 2109, so that module information generated by the apparatus is written into the external memory 2110.

In the above-mentioned configuration, when power to the apparatus is turned on, the CPU 2101 executes a boot program stored in the ROM 2012, and loads the OS stored in the HDD 2104 into the RAM 2103.

Then, the application for generating the upper layer description is started, so that the apparatus functions as the upper layer description generator 100.

The outline of processing according to the present exemplary embodiment will be described below. An upper layer generation flow according to the present exemplary embodiment includes two stages. In the first stage, the upper layer description generator 100 receives an instance template file to improve a generation environment of an upper layer. The instance template file is prepared for each of modules that can be included in a configuration of the upper layer, and includes a template used to connect each module and the other modules described in a format conforming to grammar of each language. While in the instance template file, a signal declaration and a connection are basically described in conformity with grammar of each language, two of “a portion that can be converted into a designated character string by keyword replacement” and “a portion that can repeatedly output a designated number of a designated description” can be expressed in a special description method. The above two portions are used as follows. The former is used when a specific signal name cannot be grasped during generation of the instance template file, and the latter is used when the number of modules to be connected is not previously found. A description example of the instance template file will be described below.

In the second stage, the upper layer description generator 100 receives a parameter file. The parameter file is a tabular file describing a configuration of an upper layer desired by a user to be generated. A description example of the parameter file will be described below. The upper layer description generator 100 generates an upper layer description based on information about the parameter file and a group of instance template files.

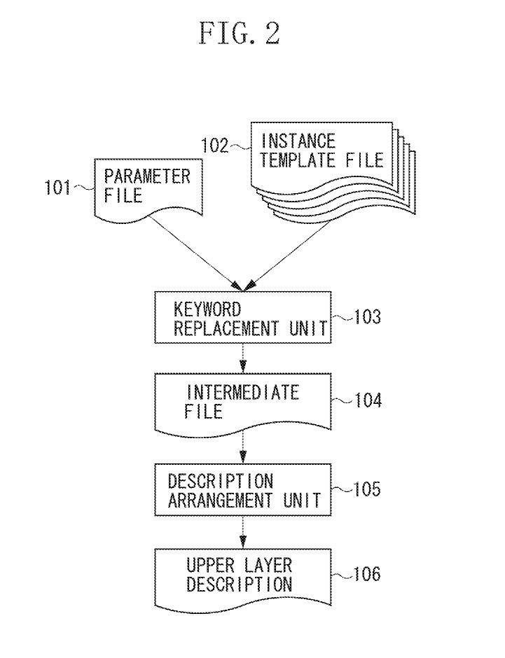

FIG. 2 illustrates an example of a functional configuration of the upper layer description generator 100. A parameter file 101 is a file for representing a configuration of an upper layer to be generated. An instance template file group 102 will be described below. A keyword replacement unit 103 performs keyword replacement of instance template files and merges. An intermediate file 104 is a file in which descriptions after the keyword replacement of the instance template files are simply arranged. A description arrangement unit 105 corrects, out of the descriptions simply arranged in the intermediate file 104, a portion of the description not conforming to language grammar. An upper layer description 106 is a finally generated upper layer description conforming to language grammar.

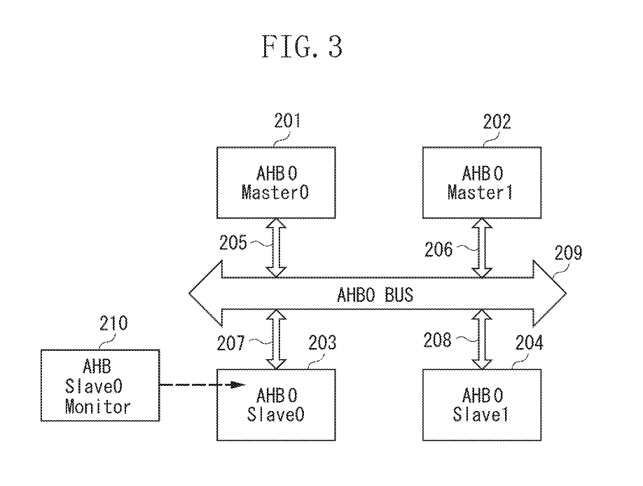

FIG. 3 illustrates an example of an upper layer that can be generated by the upper layer description generator 100. In the description of the present exemplary embodiment, the upper layer illustrated in FIG. 3 is used. A VHDL serving as a Hardware description language and an e language serving as a hardware verification language are assumed to be used in describing the upper layer. The upper layer connects two Masters and two Slaves using an ARM High Performance Bus (AHB). The Advanced Microcontroller Bus Architecture (AMBA) AHB developed by ARM Ltd is assumed to be the AHB. Two AHB masters 201 and 202 are connected. Two AHB slaves 203 and 204 are connected. Signals 205 and 206 are respectively required to connect the AHB masters 201 and 202 and a bus 209. Signals 207 and 208 are respectively required to connect the AHB slaves 203 and 204 and the bus 209. The bus 209 includes three modules, i.e., an Mux, an AHB arbiter, and an AHB decoder. An AHB slave monitor 210 reads an input/output signal in the AHB slave 203. An upper layer description relating to the AHB slave monitor 210 is described in conformity with the e language, and other descriptions are described in conformity with the VHDL.

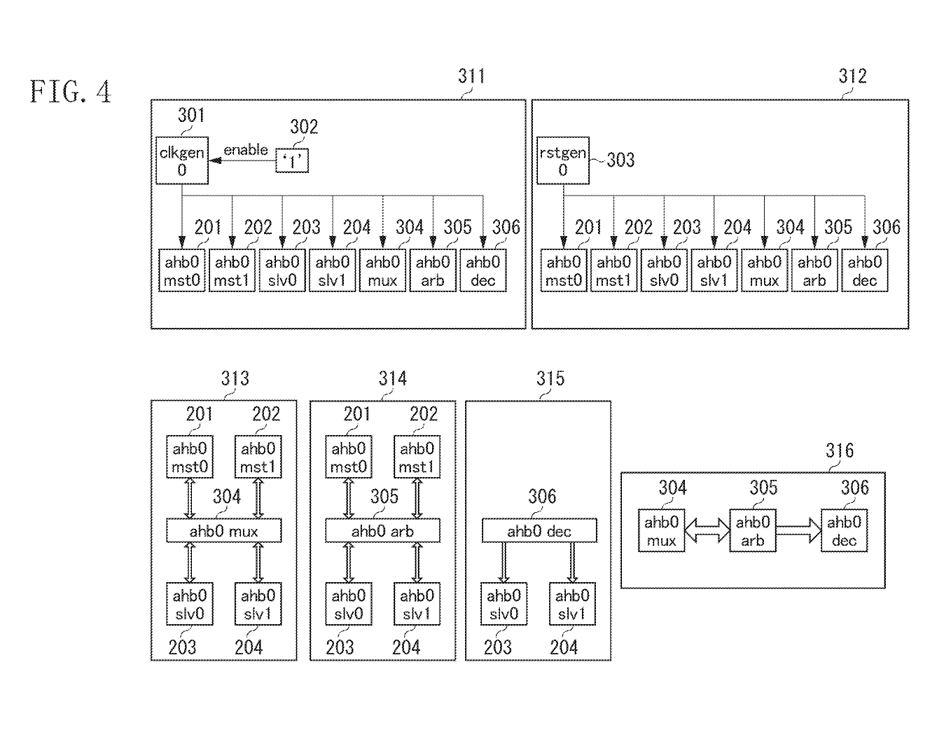

FIG. 4 illustrates a more detailed connection relationship among the upper layers illustrated in FIG. 3. The same constituent elements as those illustrated in FIG. 3 are respectively assigned the same symbols. A clock enable signal 302 for generating an enable signal to be input to a clock generation module 301, and always represents 1 (enable) in a present test bench. The connection relationship includes a signal connection relationship 311 between the clock generation module 301 and the other modules, a signal connection relationship 312 between a reset generation module 303 and the other modules, a signal connection relationship 313 among a Mux 304, the AHB master, and the AHB slave, a signal connection relationship 314 among the AHB arbiter 305, the AHB master, and the AHB slave, a signal connection relationship 315 between the AHB decoder 306 and the AHB slave, and a signal connection relationship 316 among the Mux 304, the AHB arbiter 305, and the AHB decoder 306. While a large number of signals need to be handled in the original AHB, the signals are limited for simplicity in the description of the present exemplary embodiment.

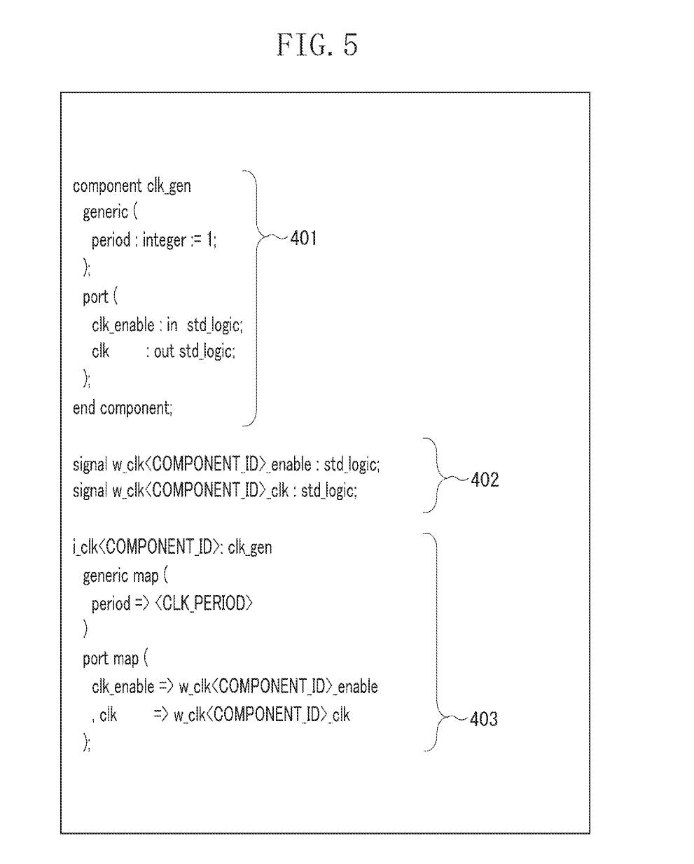

FIG. 5 illustrates an example of an instance template file relating to the clock generation module 301. The instance template file includes a component declaration 401, a signal declaration 402, and a component and instance declaration 403. In the present exemplary embodiment, “a portion that can be converted into a designated character string by keyword replacement” is defined as a portion enclosed by “<” and “>”. The reason why the keyword replacement is used will be more specifically described. For example, if a plurality of clock generation modules is required, and instance names and signal names, which respectively differ from each other, need to be prepared, an identifier (ID) is assigned to each of the clock generation modules, and a portion “<COMPONENT_ID>” of the instance template file illustrated in FIG. 5 is replaced with the above-mentioned ID. Thus, instance names and signal names, which respectively differ from each other, can be prepared. An instance temperate file relating to the reset generation module 303 has a similar format to that of the instance template file relating to the clock generation module 301, and hence description thereof is not repeated.

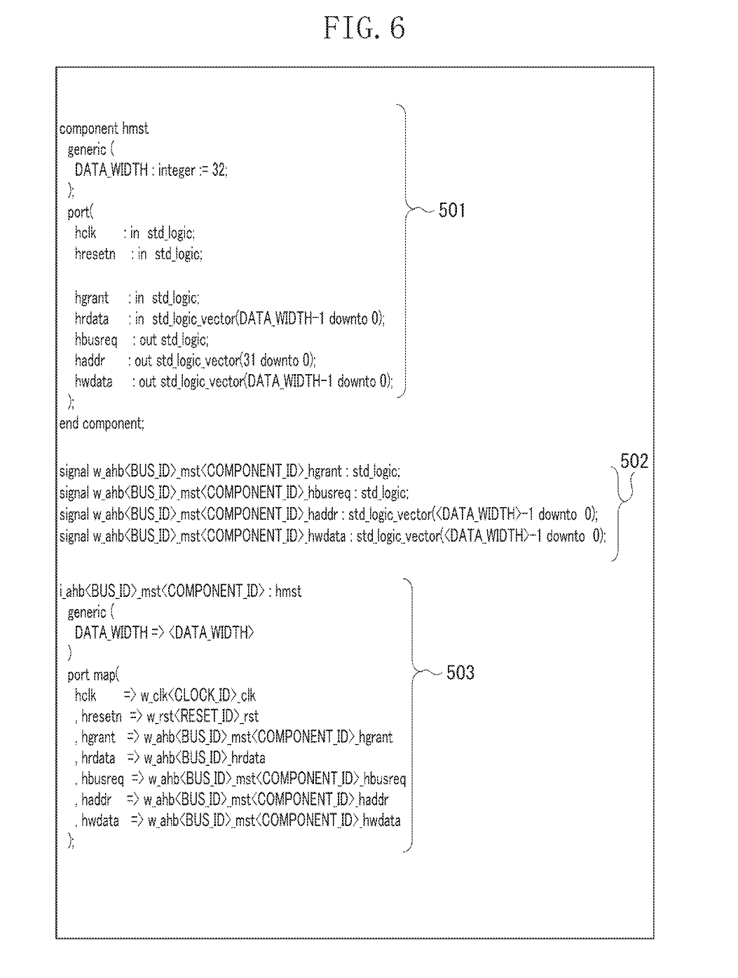

FIG. 6 illustrates an example of an instance template file relating to the AHB masters 201 and 202. The instance template file includes a component declaration 501, a signal declaration 502, and a component and instance declaration 503. In the present instance template file, a name of the component and instance declaration 503 is determined using “<BUS_ID>” and “<COMPONENT_ID>”. “<BUS_ID>” and “<COMPONENT_ID>” are respectively keyword-replaced with a bus ID and a master ID. The bus ID is used to define a name because each of a plurality of buses is desired to be distinguished if a desired upper layer owns the plurality of buses. The master ID is used to define a name because each of a plurality of masters is desired to be distinguished if one bus includes the plurality of masters. A clock signal name and a reset signal name can be found by respectively replacing portions <“CLOCK_ID>” and “<RESET_ID>” of the instance template file with each IDs.

Instance template files relating to the AHB slaves 203 and 204 respectively have similar formats to those of instance template files relating to the AHB masters 201 and 202, and hence description thereof is not repeated. An instance template file relating to the AHB slave monitor 210 written in conformity with the e language serving as a hardware verification language has a similar format to those of the instance template files relating to the AHB maters 201 and 202 in a method for expressing a signal and a name of a pass to the AHB slave, and hence description thereof is not repeated.

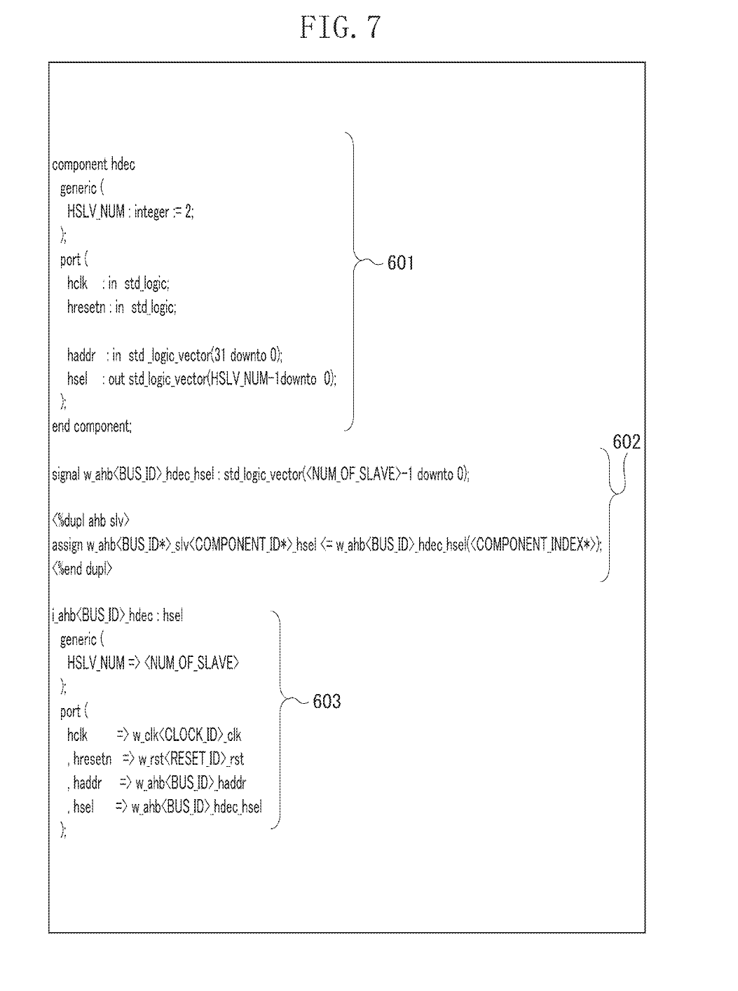

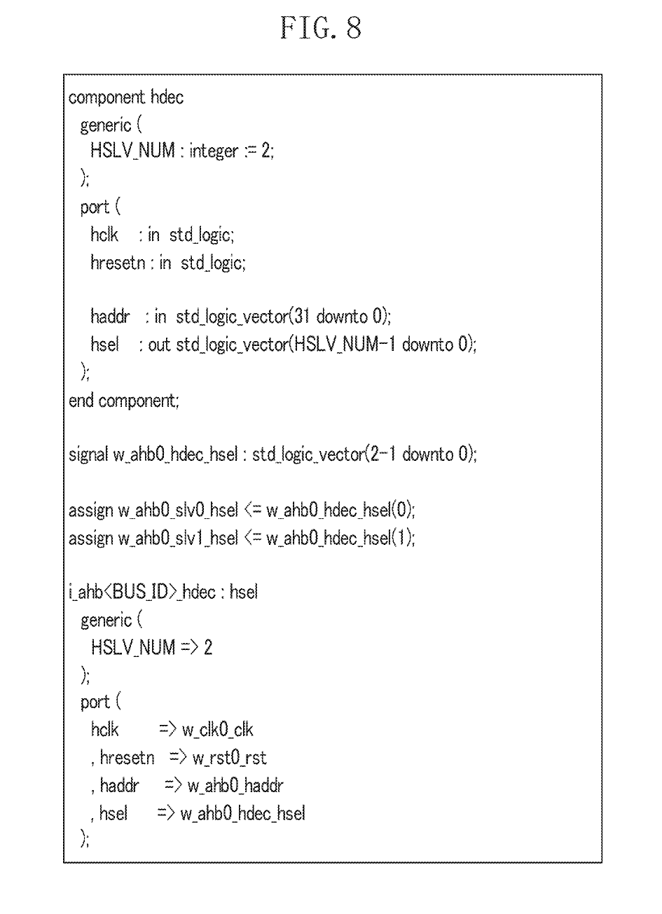

FIG. 7 illustrates an example of an instance template file relating to the AHB decoder 306. The instance template file includes a component declaration 601, a signal declaration and assign statement 602, and a component and instance declaration 603. A decoder needs to be connected to a plurality of slaves. Therefore, “a portion that repeatedly outputs a designated number of a designated description” needs to be clearly written in the instance template file. In the present exemplary embodiment, “a portion that repeatedly outputs a designated number of a designated description” is defined as a portion enclosed by “<% dupl . . . >” and “<% end dupl.>”. A portion “<% dupl ahb sly>” of the instance template file indicates that this portion is duplicated for the number which corresponds to the number of signals sly of an ahb bus. The subsequent assign statement indicates that an output from the decoder is substituted into each of the signals sly of the ahb bus. As an example, a keyword replacement result obtained when two slaves are connected to the decoder is illustrated in FIG. 8. Instance template files relating to the MUX 304 and the AHB arbiter 305 respectively have similar formats to that of the instance template file relating to the AHB decoder 306, and hence description thereof is not repeated.

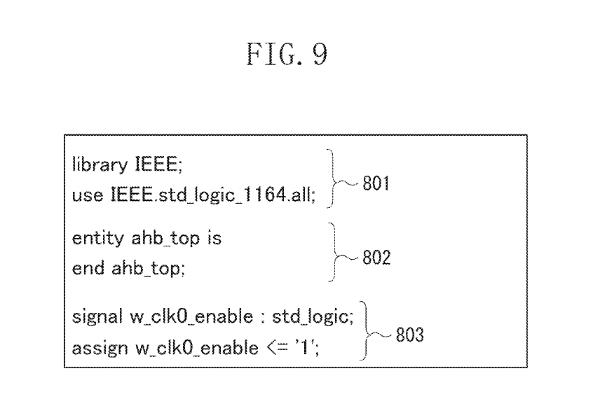

FIG. 9 illustrates one of instance template files used to generate an upper layer description and an example of a file for expressing a description not included in the other instance template files. In the present exemplary embodiment, the instance template file is referred to as a TOP instance template file. The instance template file includes a library declaration 801, an entity declaration 802, and a definition 803 of the clock enable signal 302. The instance template file does not include “a portion that can be converted into a designated keyword by keyword replacement” or “a portion that repeatedly output a designated number of a designated description”.

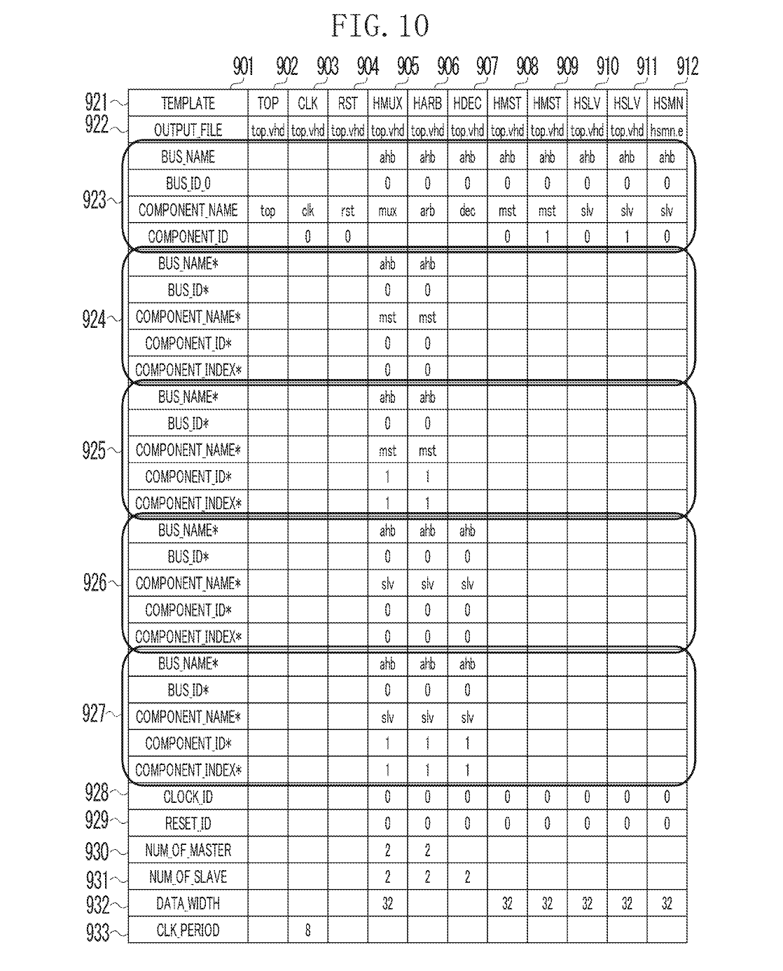

FIG. 10 illustrates an example of the parameter file 101. In the present exemplary embodiment, the parameter file 101 is in a tabular format. A column 901 represents a parameter name. A column 902 represents a parameter value of the TOP instance template file. A column 903 represents a parameter value of the clock generation module 301. A column 904 represents a parameter value of the reset generation module 303. A column 905 represents a parameter value of the MUX 304. A column 906 represents a parameter value of the AHB arbiter 305. A column 907 represents a parameter value of the AHB decoder 306. A column 908 and a column 909 respectively represent parameter values of the AHB masters 201 and 202. A column 910 and a column 911 respectively represent parameter values of the AHB slaves 203 and 204. A column 912 represents a parameter value of the AHB slave monitor 210. A row 921 represents an instance template file name used for each module. A row 922 represents an output destination file name after keyword replacement of the instance template file based on a parameter.

Rows 923 includes a bus name, a bus ID, a component name, and a component ID of each module. The component ID is a master ID if a component is a master, and is used for the keyword replacement illustrated in FIG. 5. Rows 924, 925, 926, and 927 are parameters used to duplicate “a portion that repeatedly outputs a designated number of a designated description” in the instance template file. While the column 907 represents a parameter value of the AHB decoder 306, for example, it includes information about ahb slv in two portions of each of the rows 926 and 927. Therefore, two duplications of “a portion that repeatedly outputs a designated number of a designated description” (a portion enclosed by “<% dupl . . . >” and “<% end dupl.>”) illustrated in FIG. 7 are made. A row 928 and a row 929 respectively represent a clock ID and a reset ID that are connected. A row 930 and a row 931 respectively represent the numbers of AHB masters and AHB slaves that are connected. A row 932 represents a data width. A row 933 represents a period of clocks.

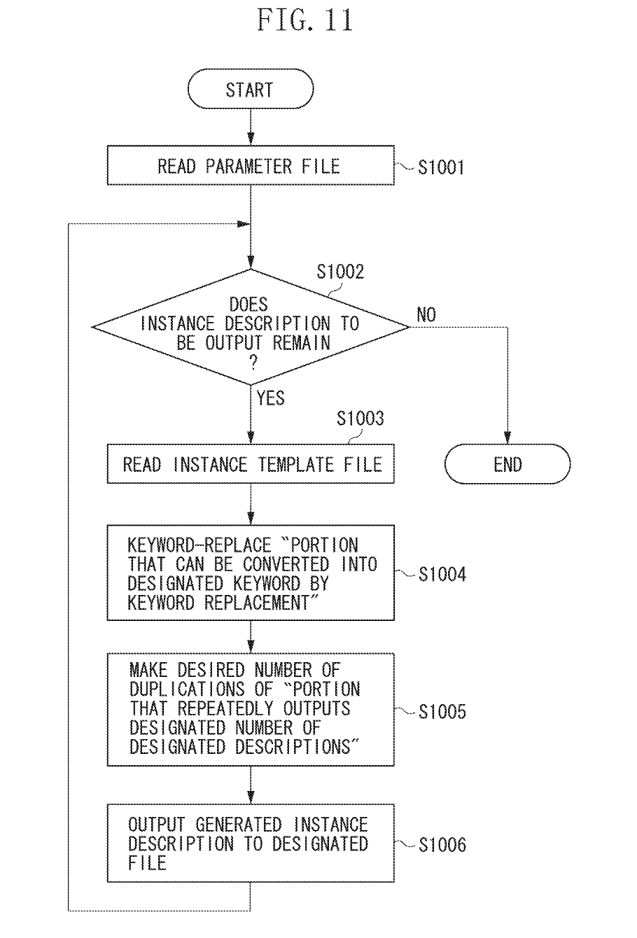

FIG. 11 is a flowchart illustrating an example of processing of the keyword replacement unit 103. In step S1001, the keyword replacement unit 103 reads the parameter file 101. In step S1002, the keyword replacement unit 103 determines whether there remains, out of modules required to constitute an upper layer written in the parameter file 101, the module for which an instance description has not been generated yet. If an instance description has been generated for all the modules (NO in step S1002), the processing ends. If an instance description to be generated remains (YES in step S1002), the processing proceeds to step S1003.

In step S1003, the keyword replacement unit 103 selects the module, for which an instance description has not been generated yet, out of the modules in the parameter file 101, and reads an instance template file corresponding to the selected module. In step S1004, the keyword replacement unit 103 keyword-replaces “a portion that can be converted into a designated keyword by keyword replacement” in the instance template file into a designated character string.

In step S1005, the keyword replacement unit 103 makes a designated number of duplications of “a portion that repeatedly output a designated number of a designated description” in the instance template file. In step S1006, the keyword replacement unit 103 outputs a result of the conversion, which has been performed in steps S1004 and S1005, to a file. The file, to which the result has been output, is an intermediate file 104.

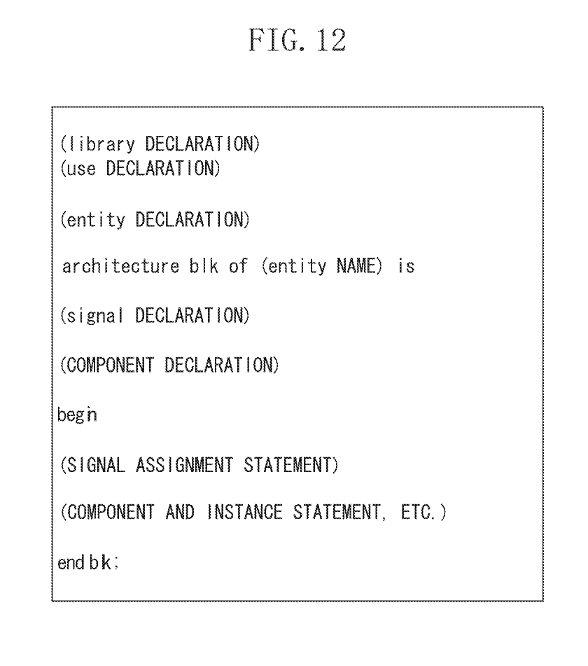

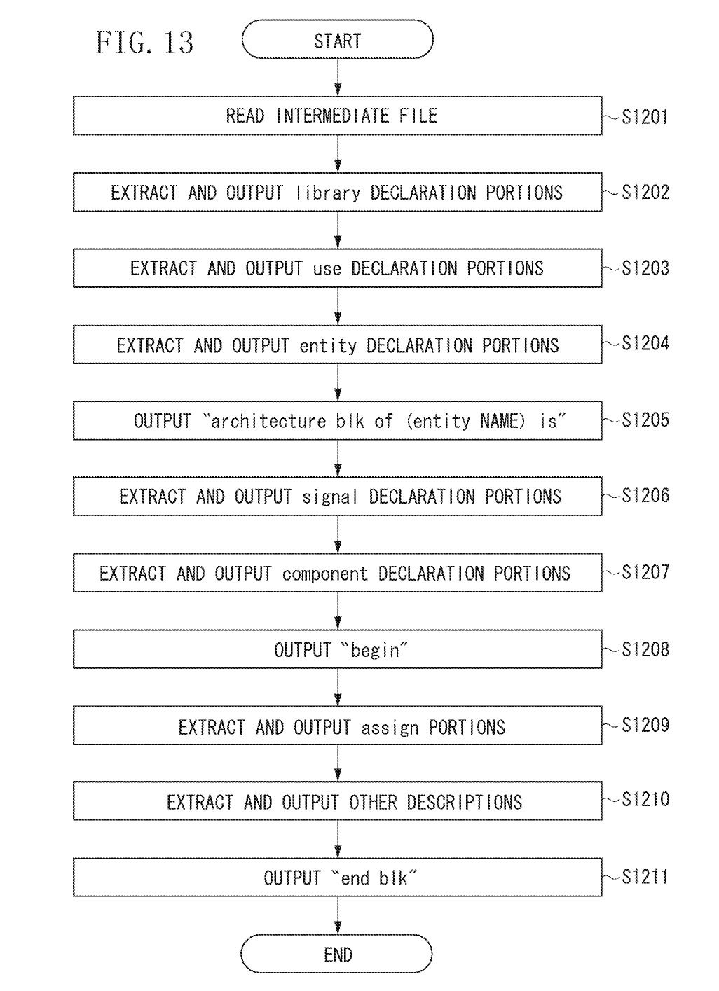

FIG. 12 illustrates the outline of a description in a VHDL of the upper layer description 106 to be finally output. An algorithm for converting the intermediate file 104 into a format illustrated in FIG. 12 will be described below. FIG. 13 is a flowchart illustrating an example of processing relating to a VHDL of the description arrangement unit 105. Processing relating to the e language is not performed in the flowchart because a description of the intermediate file 104 can be directly used as the upper layer description 106.

In step S1201, the description arrangement unit 105 reads the intermediate file 104. In step S1202, the description arrangement unit 105 extracts all library declaration portions from the intermediate file 104, and writes the portions into an output file. In step S1203, the description arrangement unit 105 extracts all use declaration portions from the intermediate file 104, and additionally attaches the portions to the tail of the output file. In step S1204, the description arrangement unit 105 extracts all entity declaration portions from the intermediate file 104, and additionally attaches the portions to the tail of the output file. In step S1205, the description arrangement unit 105 additionally attaches a character string “architecture blk of (an entity name) is” to the tail of the output file.

In step S1206, the description arrangement unit 105 extracts all signal declaration portions from the intermediate file 104, and additionally attaches the portions to the tail of the output file. If there is a plurality of identical signal declarations, the description arrangement unit 105 changes the signal declarations into only one declaration. In step S1207, the description arrangement unit 105 extracts all component declaration portions from the intermediate file 104, and additionally attaches the portions to the tail of the output file. If there is a plurality of identical component declarations, the description arrangement unit 105 changes the component declarations into only one declaration.

In step S1208, the description arrangement unit 105 additionally attaches a character string “begin” to the tail of the output file. In step S1209, the description arrangement unit 105 extracts all assign portions from the intermediate file 104, and additionally attaches the assign portions to the tail of the output file. In step S1210, the description arrangement unit 105 extracts descriptions other than the foregoing from the intermediate file 104, and additionally attaches the descriptions to the tail of the output file. In step S1211, the description arrangement unit 105 additionally attaches a character string “end blk;” to the tail of the output file. The output file is in the format illustrated in FIG. 12 by the processing of the description arrangement unit 105. Therefore, the output file can be used as a description in a VHDL of the upper layer description 106.

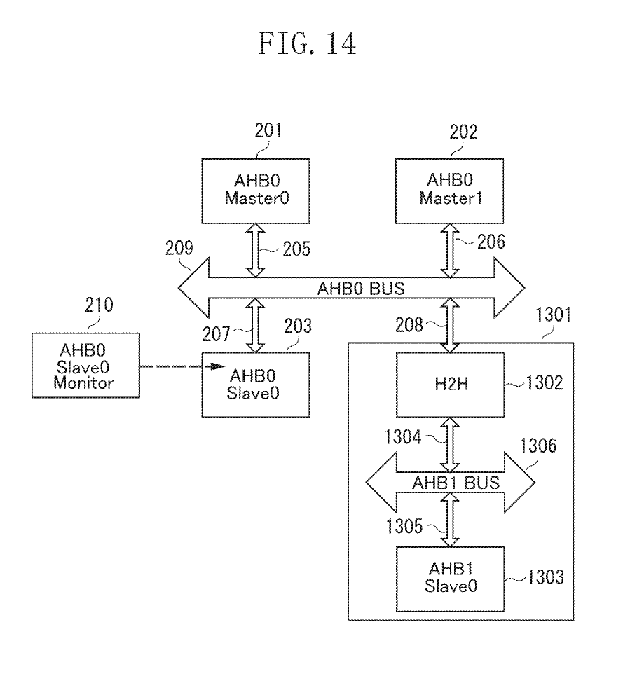

A method for adding another module to the upper layer illustrated in FIGS. 3 and 4 will be described below, to introduce a specific example of a change in the upper layer configuration in the present exemplary embodiment. Work required to add a new module in the present exemplary embodiment includes generation of an instance template file for the new module and correction of a parameter file. When the instance template file is generated, the entire upper layer configuration need not be considered. A portion, which does not associate with addition of the new module, of description contents of the instance template file and the parameter file need not be changed. Therefore, the upper layer configuration can be changed by minimal work. FIG. 14 illustrates a configuration of a new upper layer for representing a module addition method. The same constituent element to that illustrated in FIG. 3 is assigned the same symbol.

A replacement portion 1301 in the new upper layer is at a position of the AHB slave 204 illustrated in FIG. 3. An AHB bus bridge H2H 1302 has its function operating as an AHB slave in an AHB bus 209 and operating as an AHB master in an AHB bus 1306, described below. An AHB slave 1303 is similar to the AHB slave 203 and the AHB slave 204. A signal 1304 connects the AHB master 1302 and the AHB bus 1306, and is similar to the signals 205 and 206. A signal 1305 connects the AHB bus 1306 and the AHB slave 1303, and is similar to the signals 207 and 208. The AHB bus 1306 is similar to the bus 209.

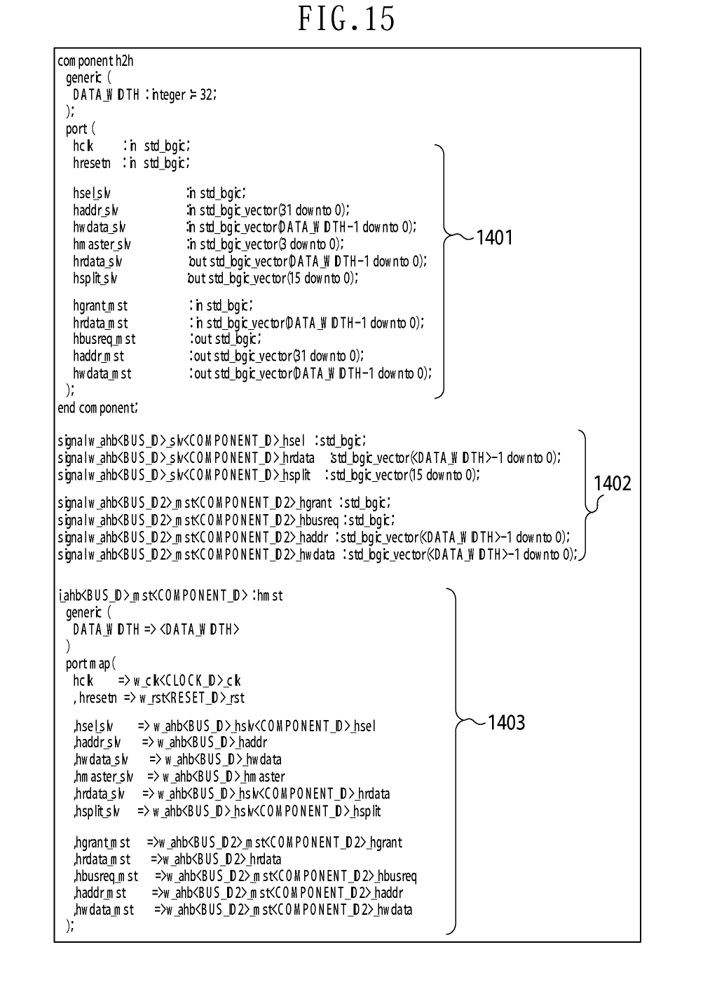

FIG. 15 illustrates an example of an instance template file relating to the AHB bus bridge 1302. The instance template file includes a component declaration 1401, a signal declaration 1402, and a component and instance declaration 1403. The AHB bus bridge 1302 includes a slave port and a master port to make a bus bridge. BUS_ID and COMPONENT_ID obtained when the AHB bus bridge 1302 is viewed from the AHB bus 1306 are respectively represented as BUS_ID2 and COMPONENT_ID2 in the instance template file.

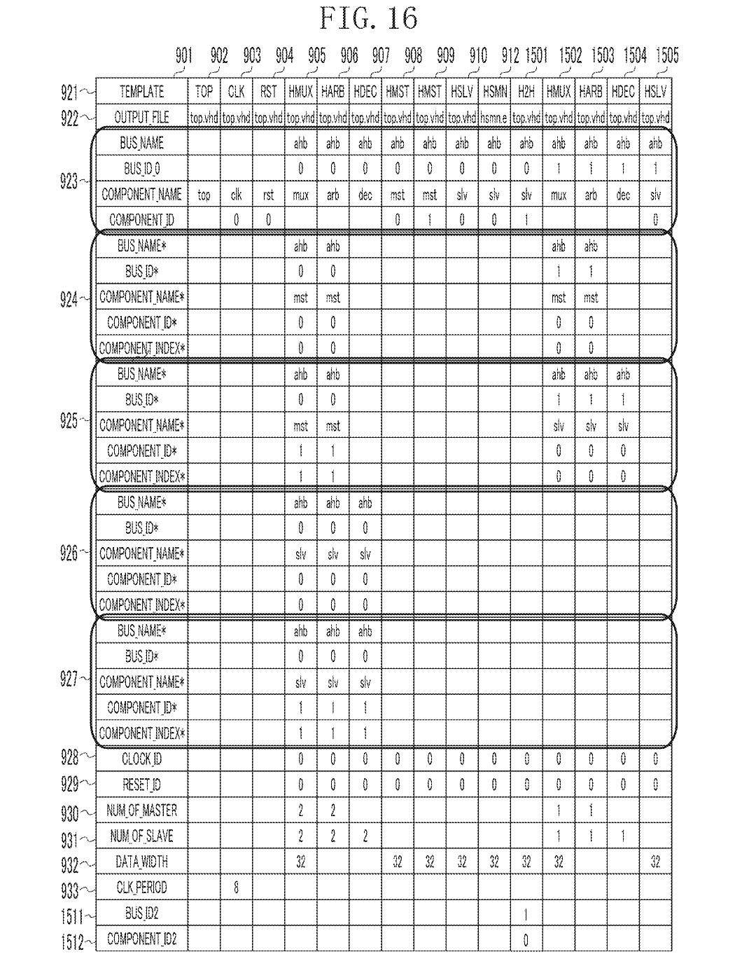

FIG. 16 illustrates an example of a parameter file for generating the new upper layer illustrated in FIG. 14 in the present exemplary embodiment. The same constituent elements as those illustrated in FIG. 10 are respectively assigned the same symbols. A column 1501 represents a parameter value relating to the AHB bus bridge 1302. A column 1502 represents a parameter value relating to an MUX in the AHB bus 1306, like in the column 905. A column 1503 represents a parameter value relating to an AHB arbiter in the AHB bus 1306, like in the column 906. A column 1504 represents a parameter value relating to an AHB decoder in the AHB bus 1306, like in the column 907. A column 1505 represents a parameter value relating to the AHB slave 1303. A row 1511 represents BUS_ID of the AHB bus 1306 to which the AHB bus bridge 1302 is connected as an AHB master. A row 1512 represents COMPONENT_ID obtained when the AHB bus bridge 1302 is viewed from the AHB bus 1306 to which the AHB bus bridge 1302 is connected as an AHB master. The upper layer configuration can be changed only by adding an instance template file and correcting a parameter file. Therefore, steps required to generate the upper layer illustrated in FIG. 14 include only addition of the instance template file illustrated in FIG. 15 and correction of the parameter file illustrated in FIG. 16. Thus, according to the present exemplary embodiment, the upper layer configuration can be changed by minimal work.

Another exemplary embodiment will be described. The present invention is also implemented by performing the following processing. More specifically, a software (a program) for implementing the functions in the above-mentioned exemplary embodiment is supplied to a system or an apparatus via a network or various types of storage media, and is read out and executed by a computer (or a CPU or a micro-processing unit (MPU)) in the system or the apparatus.

As described above, according to each of the above-mentioned exemplary embodiments, work for changing the upper layer configuration can be reduced. Two reasons are provided. The first reason is that even if a new type of module is required to change a configuration, an instance template file corresponding to the new type of module may be generated without requiring a maximum configuration. The second reason is that the upper layer configuration can be changed only by changing a parameter file that designates the upper layer configuration in addition to charging the instance template file. The instance template file is easy to generate because it has a form substantially conforming to grammar of a Hardware description language. Even if the instance template file needs to be changed, therefore, the change can be easily coped with.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2012-051631 filed Mar. 8, 2012 and No. 2012-225205 filed Oct. 10, 2012, which are hereby incorporated by reference herein in their entirety.

What is claimed is:

1. An upper layer description generator comprising:
a generation unit configured to generate an instance description based on one or more instance template files in which an instance description for each module is described by a keyword and a parameter file representing a configuration of an upper layer; and
an arrangement unit configured to arrange the instance description generated by the generation unit as a description conforming to grammar of each language, and output an upper layer description.

2. The upper layer description generator according to claim 1,
wherein the instance template file includes two description of a portion that can be converted into a designated character string by keyword replacement and a portion that can repeatedly output a designated number of a designated description, and
wherein the generation unit generates the instance description by keyword replacement based on the instance template file and the parameter file.

3. The upper layer description generator according to claim 1,
wherein the parameter file includes a parameter value to be replaced, which corresponds to each of the keywords in the instance template file, and
wherein the generation unit generates the instance description by keyword replacement based on the instance template file and the parameter file.

4. The upper layer description generator according to claim 1,
wherein the instance template file includes a description conforming to a Hardware description language, and
wherein the generation unit generates the instance description by keyword replacement based on the instance template file and the parameter file.

5. The upper layer description generator according to claim 1, wherein the generation unit generates the instance description by keyword replacement.

6. An upper layer description generation method performed by an upper layer description generator, comprising:
generating an instance description by keyword replacement based on one or more instance template files in which an instance description for each module is described by a keyword and a parameter file representing a configuration of an upper layer; and
arranging the instance description generated by the generating as a description conforming to grammar of each language, and outputting an upper layer description.

7. A non-transitory computer readable storage medium storing a computer program causing a computer to execute:
generating an instance description by keyword replacement based on one or more instance template files in which an instance description for each module is described by a keyword and a parameter file representing a configuration of an upper layer; and
arranging the instance description generated by the generating as a description conforming to grammar of each language, and outputting an upper layer description.
